(19) United States
(12) Patent Application Publication
(10) Pub. No.: US 2024/0208374 A1
(43) Pub. Date: Jun. 27, 2024

(54) MAGNETIC CONNECTOR

(71) Applicant: ARTSANA USA, INC., Lancaster, PA (US)

(72) Inventors: Michael L. LONGENECKER, Lancaster, PA (US); Michael S. DEGRACE, Red Lion, PA (US); Matthew J. RANSIL, Richland, PA (US)

(21) Appl. No.: 18/590,239

(22) Filed: Feb. 28, 2024

Related U.S. Application Data
(63) Continuation of application No. 17/975,096, filed on Oct. 27, 2022, now Pat. No. 11,945,344.
(60) Provisional application No. 63/293,325, filed on Dec. 23, 2021.

(51) Int. Cl. B60N 2/26; A44B 11/25

(52) U.S. Cl. CPC B60N 2/265; A44B 11/2519; A44B 11/2546

(57) ABSTRACT

A connector for joining two parts has a base with a post and a latch part with a receptacle for receiving the post. The post includes a magnetic element. A magnetic slide having two magnetic elements of opposite polarity is moveably disposed on the latch part and includes a mechanical latching slide disposed thereon. Movement of the magnetic slide aligns the magnetic elements in either an attractive or repulsive alignment with the post magnetic element. Magnetic slide movement into the repulsive alignment also moves the latching slide to release engagement with the base part and allow magnetic repulsion to urge the post out of engagement with the receptacle.

### CROSS-REFERENCE TO RELATED APPLICATIONS

This application is a continuation of U.S. Nonprovisional application Ser. No. 17/975,096 filed Oct. 27, 2022, and claims the benefit of priority of U.S. Provisional Application 63/293,325 filed Dec. 23, 2021, now expired.

### BACKGROUND OF THE INVENTION

Restraint belts in child safety seats typically comprise a pair of lap belt portions, a crotch belt, and a pair of shoulder belt portions all centrally connected in front of the child's abdomen to hold the child in place. Additional security for the infant child is commonly provided by adding an additional connection between the shoulder belt portions adjacent to the child's chest.

Most harness belt connectors are in addition to a primary connector which must be operated to secure the infant child in the seat or removing the infant child therefrom. Many harness belt connectors require caregivers to either engage the connector on one of the shoulder harness straps or operate complex connectors to join or separate the adjacent harness straps. These complex actions often require two hands to operate. This requirement is further complicates the task of moving an infant into or out of the seat, especially if the infant is moving or resisting the caregiver.

An improved harness buckle configured to be connected or disconnected easily using only one hand that provides a strong, secure connection when connection would be of great benefit. Additional benefits would be realized by a harness buckle that includes means for urging the buckle portions together or apart during the connecting/disconnection operations to further ease the task of operating the buckle with a single hand.

### SUMMARY OF THE INVENTION

Accordingly, the present invention, in any of the embodiments described herein, may provide one or more of the following advantages:

It is an object of the present invention to provide a buckle for a child safety seat harness comprising a base part and a latch part and a releasable latching mechanism disposed on the latch part that includes a plurality of magnetic elements arranged to urge the base part and the latch part into engagement during the connection operation and to urge the base part and the latch part apart during the disconnection operation. The latching mechanism comprises a moveable slide part having two magnetic elements with opposite polarity arranged to interact with a third magnetic element disposed on the base part wherein the magnetic elements on the magnetic slide are individually aligned with the third magnetic element to attract or repel dependent upon the position of the slide part.

It is a further object of the present invention to provide a buckle for a child safety seat harness wherein the slide part of the releasable latching mechanism includes a magnetic slide and a catch slide, each arranged for bi-directional movement along parallel axes, the magnetic slide being normally urged toward a latched position by a first biasing element, the catch slide also being normally urged toward a latched position by a second biasing element, the biasing force of the first biasing element being substantially greater than the biasing force of the second biasing element.

It is a further object of the present invention to provide a buckle for a child safety seat harness comprising a releasable latching mechanism that provides for at least two latching interfaces between the base part and the latch part which increase the resistance to separation of the buckle when the buckle parts are connected, and the latching mechanism is engaged. The latching mechanism includes a bi-directionally moveable catch slide that is biased toward a latched position, the biasing element providing minimal biasing force so that the catch slide can be easily displaced to engage a catch structure as the buckle portions are moved into a connected configuration.

It is a still further object of the present invention to provide a buckle for a child safety seat comprising a base part and a latch part, the latch part having a releasable latching mechanism that includes a plurality of magnetic elements arranged to urge the base and latch parts into engagement during the connection operation and to urge the base and latch parts apart during the disconnection operation that is durable in construction, inexpensive of manufacture, carefree of maintenance, easily assembled, and simple and effective to use.

These and other objects are achieved in accordance with the present invention by a buckle for a child safety seat harness comprising a base part and a latch part, the latch part having a releasable latching mechanism that includes a plurality of magnetic elements arranged to urge the base and latch parts into engagement during the connection operation and to urge the base and latch parts apart during the disconnection operation. The buckle includes a magnetic slide and a catch slide, each arranged for bi-directional movement along parallel axes, the magnetic slide being normally urged toward a latched position by a first biasing element, the catch slide also being normally urged toward a latched position by a second biasing element, the biasing force of the first biasing element being substantially greater than the biasing force of the second biasing element and the sliding displacement of the magnetic slide being greater than the sliding displacement of the catch slide.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 illustrates a first embodiment of a harness belt buckle useful for a child safety seat shown in the engaged and latched position suited for use;

FIG. 2 is a view of the harness belt buckle of FIG. 1 wherein the release actuator is shown in the disengaged position in preparation to uncouple the buckle;

FIG. 3 is a view of the harness belt buckle of FIG. 2 wherein the buckle portions are separated;

FIG. 4 is a partial view of the harness belt buckle of FIG. 1 showing the base part of the buckle;

FIG. 5 is a partial exploded view of the harness belt buckle of FIG. 1;

FIG. 6 is a top perspective view of the slide assembly magnetic slide and catch slide;

FIG. 7 is a bottom perspective view of the slide assembly magnetic slide and catch slide shown in FIG. 6;

FIG. 8 is a partial view of the latching mechanism of the harness belt buckle of FIG. 1 shown in the engaged and latched position;

FIG. 9 is a partial view of the latching mechanism of the harness belt buckle of FIG. 2 shown in the disengaged position;

FIG. 10 is a partial view of the latching mechanism of the harness buckle of FIG. 3 shown with the buckle portions separated;

FIG. 11 is a partial view of the internals of the latching mechanism as positioned in FIG. 8;

FIG. 12 is a partial view of the internals of the latching mechanism as positioned in FIG. 9;

FIG. 13 is a view of the bottom side of the latching portion of the buckle as positioned in the engaged and latched position of FIG. 8;

FIG. 14 is a view of the bottom side of the latching portion of the buckle as positioned in the disengaged position of FIG. 9;

FIG. 15 illustrates a second embodiment of a harness belt buckle useful for a child safety seat shown in the engaged and latched position suited for use;

FIGS. 16 and 17 are partial internal views of the harness belt buckle of FIG. 15; and

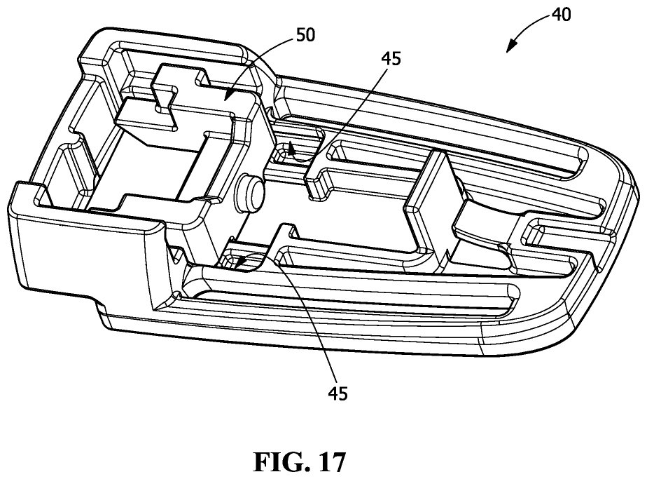

FIG. 18 is a section view of the harness belt buckle shown in FIG. 1 taken along section line 18-18.

### DESCRIPTION OF THE PREFERRED EMBODIMENT(S)

Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Also, any reference herein to the terms “up” or “down,” or “top” or “bottom” are used as a matter of mere convenience, and are determined with reference to harness buckle as it would normally rest on a level surface. Furthermore, the various components shown or described herein for any specific application of this invention can be varied or altered as anticipated by this invention and the practice of a specific application of any element may already be widely known or used in the art by persons skilled in the art and each will likewise not therefore be discussed in significant detail. When referring to the figures, like parts are numbered the same in all of the figures.

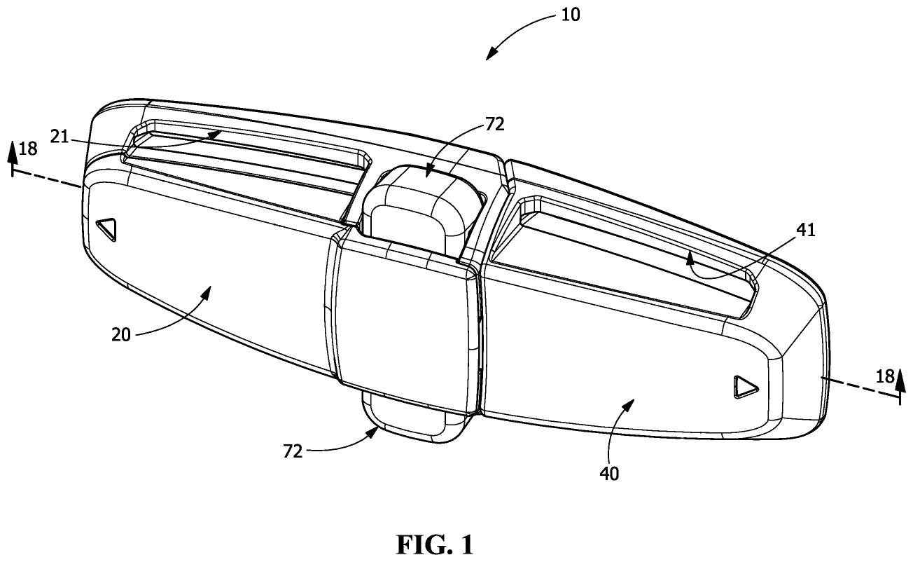

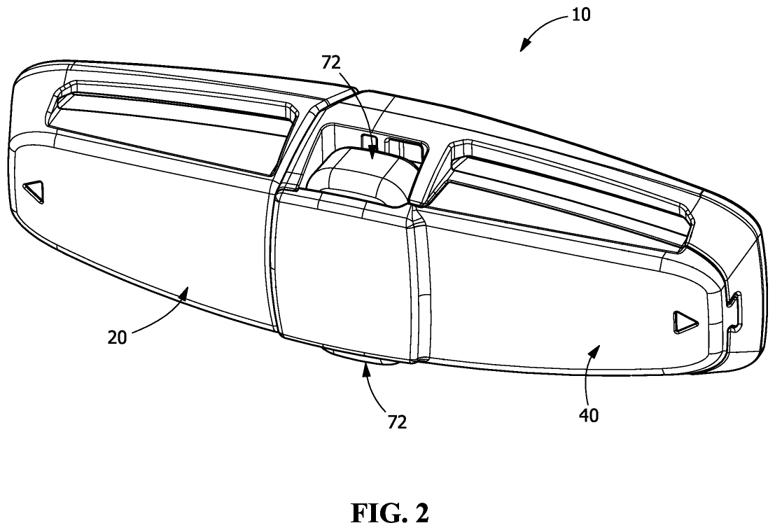

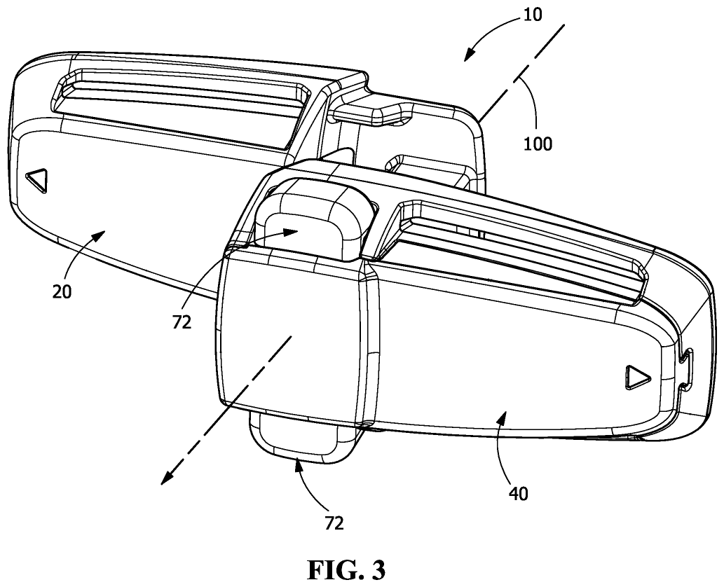

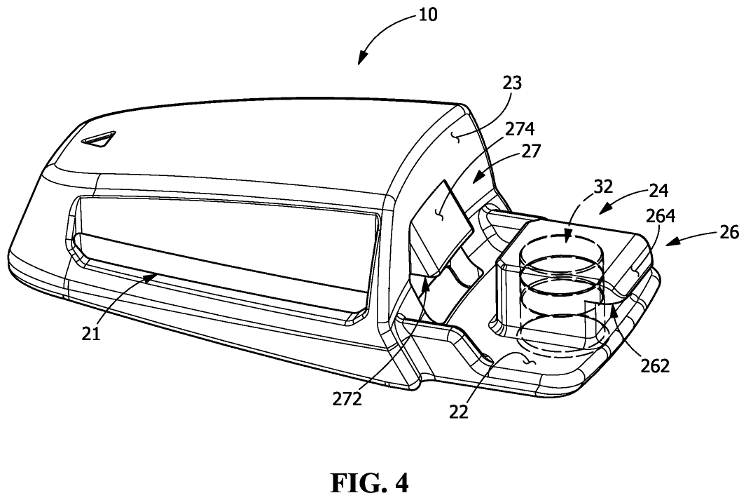

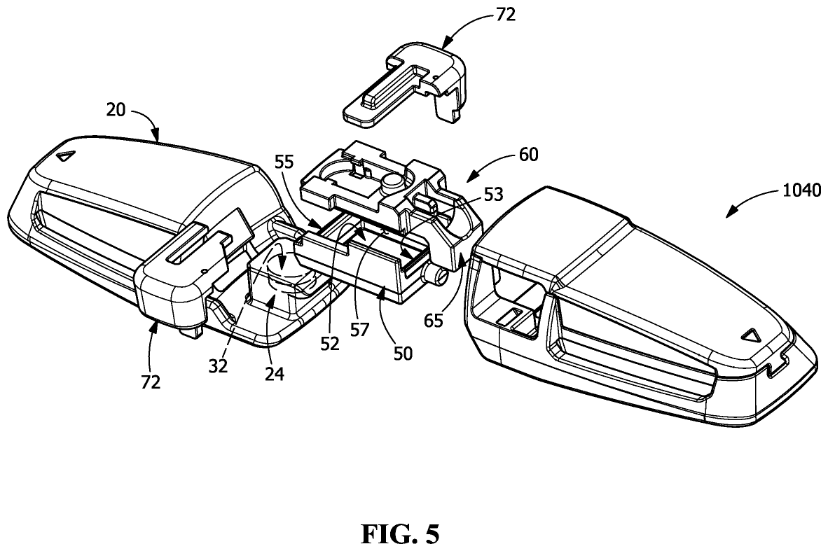

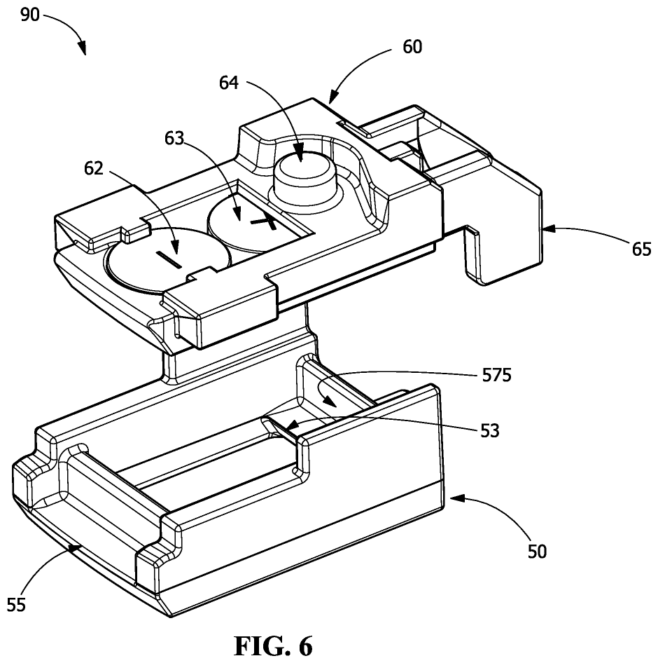

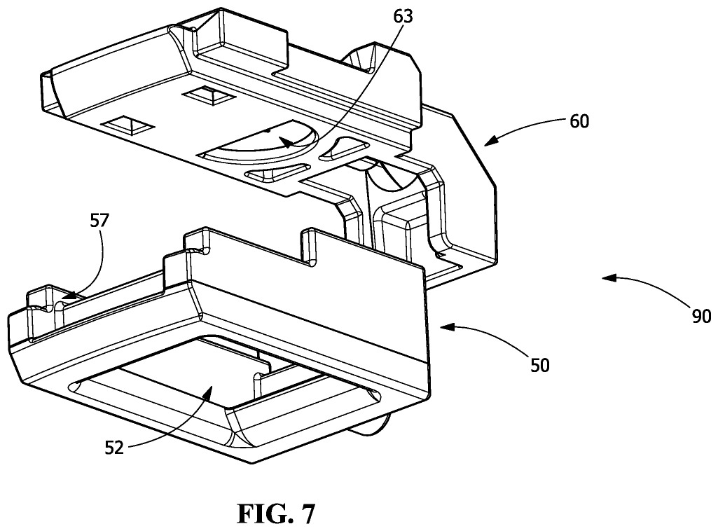

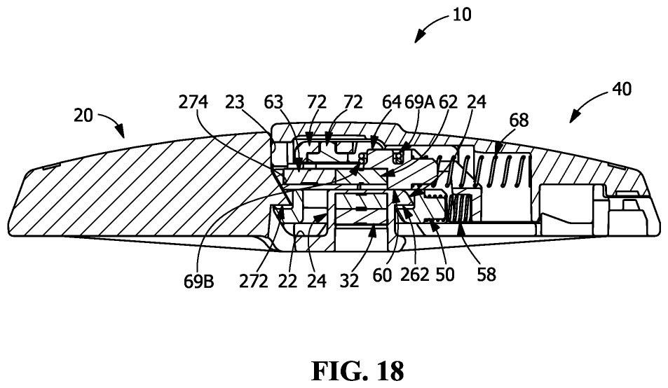

Referring to FIGS. 1 through 12, and 18, a first embodiment of a shoulder harness buckle assembly 10 is presented. The shoulder harness buckle assembly 10 comprises a base part 20 and a latch part 40, each configured for with openings 21, 41 to slidingly receive respective right and left shoulder harness straps in a manner allowing vertical adjustment of the buckle assembly on the straps when in use. Operably connecting the base and latch parts joins the straps and inhibits lateral separation thereof and improves restraining capability of the harness.

In one embodiment the base part 20 includes base surface 22 having a post 24 extending upwardly therefrom and an adjacent backstop structure 23 spaced apart from the post. A first fixing flange 26 extends outwardly from a side surface the post. A second fixing flange 27 extends outwardly from a surface of the backstop structure. The fixing flanges are each arranged to extend in the same direction from their respective surfaces and are both spaced apart from the base surface. The fixing flanges each include a locking surface 262, 272 and a guiding surface 264, 274.

A first magnetic element 32 is disposed in a distal end of the post. The first magnetic element has a first polarity that is aligned to magnetically attract or repel other magnetic elements adjacently positioned, the magnetic forces acting along an axis generally perpendicularly to the base surface.

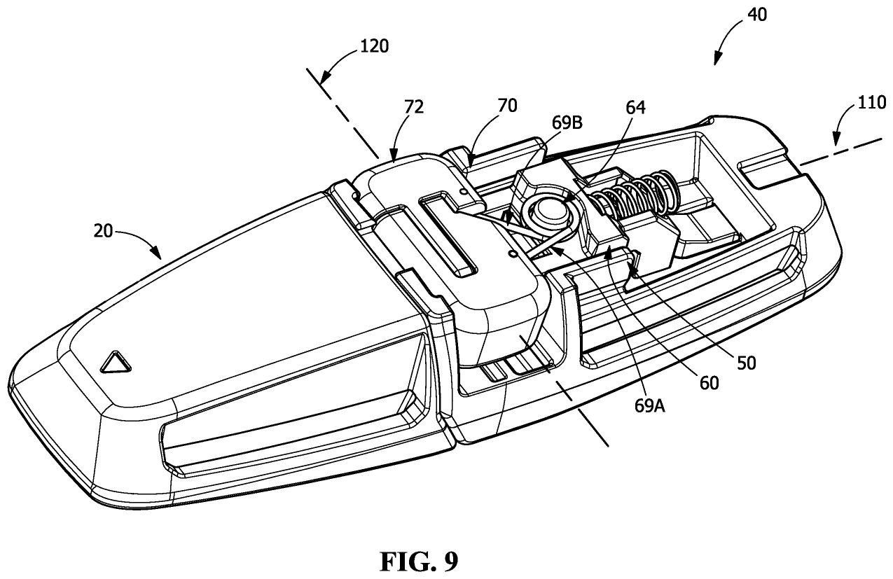

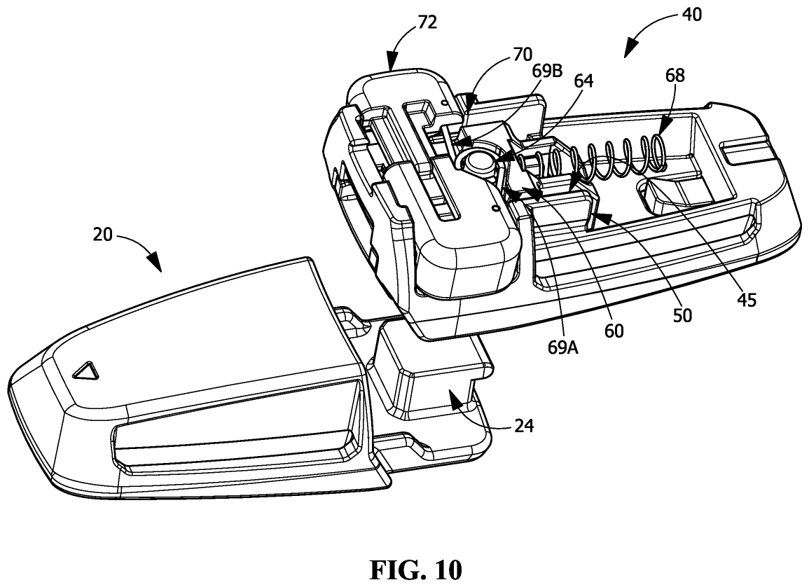

The latch part 40 includes a base surface 42 and an opening 44 through which the post 24 of the base part may be received by relative motion generally perpendicular to the respective base planes of the base and latch parts, referred to as an engagement axis 100. The latch part 40 further includes a first guide structure 45 proximate to the opening configured to constrain motion of a slide assembly 90 to bi-directionally along a slide axis 110 between opposing latched (FIG. 9) and unlatched (FIG. 10) positions and allow the slide assembly to interact with the post structure engaged in the opening. Slide axis 110 is generally longitudinally aligned with the buckle assembly 10. Slide assembly 90 is configured to selectively engage fixing flanges 26, 27 on the base part to operably connect the latching portion to the base part when the slide assembly is in the latched position. Displacing the slide assembly to the unlatched position allows the base part to the separated from the latch part to facilitate separation of harness straps for removal of an infant occupant from the safety seat.

Slide assembly 90 may comprise a catch slide 50, a magnetic slide 60, and an actuator 70 for selectively releasing the harness buckle assembly 10 so that the base part 20 and latch part 40 may be separated. Catch slide 50 is configured to retain the base and latch parts connected when the buckle assembly is operably connected. Magnetic slide 60 is configured to move the catch slide in a releasing direction to permit separation of the base and latch parts, and to reposition magnetic elements contained therein to either attract or repel the first magnetic element, dependent upon the position of the magnetic slide. Catch slide 50 and magnetic slide 60 are moveable in relation to one another. Resilient elements are provided to bias both slides toward their respective latched/engaged positions.

In one embodiment, catch slide 50 is configured with an opening 52 through which post 24 may be extended and includes first and second catch structures 53, 55 that are configured to matingly engage the first and second fixing flange locking surfaces 262, 272 when the catch slide 50 is in the latched position, the first and second catch structures 53, 55 disengaging the first and second fixing flange locking surfaces 262, 272 when the catch slide is moved toward the unlatched position. A first resilient element 58 is provided to bias the position of the catch slide 50 toward the latched position while allowing catch slide movement toward the unlatched position as the base and latch parts 20, 40 of the buckle are moved toward a connected configuration, displacement of the catch slide 50 caused by contact between the catch structures 53, 55 and the engaging guide structures 264, 274 on the fixing flanges 26, 27 and the buckle portions are moved into engagement. The first resilient element is configured with a relatively low spring rate compared to the spring rate of the second resilient element to minimize resistive force when engaging the latch parts.

In one embodiment fixing flanges 26, 27 may be oriented laterally from the post 24 and the first and second catch structures 53, 55 on the catch slide 50 be configured to engage the lateral sides of the post. This configuration may be less ideal as greater displacement of the catch slide 50 is necessary to fully disengage the latch assembly and the buckle bending strength, when latched, is reduced compared to other catch structure orientations.

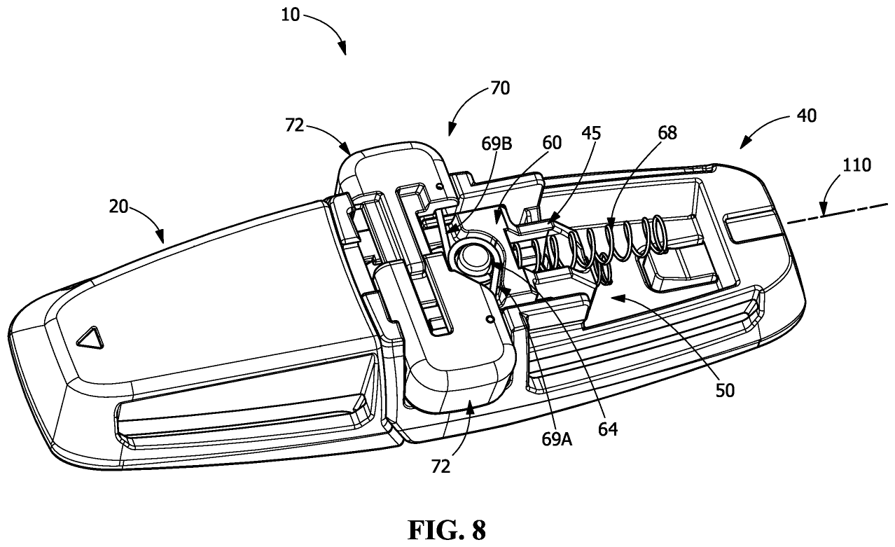

The catch slide 50 may include a second guide structure 57 which constrains motion of a magnetic slide 60 to bi-directional in a plane parallel to the base plane between opposing engaging (FIG. 8) and releasing positions (FIG. 9). A driving structure 65 on the magnetic slide engages ends of the second guide structure 57 in a manner limiting movement of the magnetic slide that may occur without corresponding movement of the catch slide within the first guide structure 45. Once the driving structure 65 contacts a driving end 575 of the latch guide structure, continued movement of the magnetic slide also causes the catch slide to move.

The magnetic slide 60 includes a second magnetic element 62 and a third magnetic element 63. The second and third magnetic elements 62, 63 have second and third polarities, respectively, aligned to act generally perpendicularly to the base plane. The first and second polarities are configured to create an attractive force between the magnetic elements while the first and third polarities are configured to create a repulsive force between the magnetic elements. These are illustrated with “+” and “−” symbols on the respective magnetic elements in the figures.

A second resilient element 68 is provided to bias the magnetic slide toward the engaging position. The second resilient element is configured with a relatively high spring rate compared to the spring rate of the first resilient element to minimize the likelihood of an accidental release of the buckle. An actuator 70 is provided to act on the magnetic slide 60 to selectively urge it toward the releasing position. Initial movement of the magnetic slide toward the releasing position does not result in movement of the catch slide as the magnetic slide moves within the limits of the second guide structure 57. Once the travel limiter 65 of the magnetic slide contacts the end 575 of the second guide structure 57, continued movement of the actuator 70 acting on the magnetic slide 60 causes the catch slide 50 to begin moving from the latched position toward the unlatched position. The initial movement of the magnetic slide is necessary to realign the magnetic elements which requires greater slide displacement in relation to the latch part than does the catch slide to disengage the catch structures 53, 55 from the post fixing flanges 26, 27.

When the magnetic slide 60 is positioned in the engaged position, attractive forces between the first magnetic element 32 located in the post 24 and the second magnetic element 62 located in the magnetic slide 60 draw the post into the opening 44 of the latch part along the engagement axis 100 to engage the harness buckle. As the post 24 enters the opening 44, the catch slide 50 is momentarily displaced to allow engagement of the fixing flanges with the catch surfaces. Once engaged, reverse movement of the post 24 along the engagement axis 100 to withdraw it from the opening 44 is precluded thereby retaining latch part 40 secured to base part 20.

When releasing the harness buckle, the magnetic slide 60 is shifted by the actuator 70 toward the disengaged position. As the magnetic slide begins moving, the second magnetic 62 element is moved from alignment with the first magnetic element 32 thereby reducing the attractive force. The third magnetic element 63 is positioned on the magnetic slide 60 adjacent to the second magnetic element and is simultaneously moved toward alignment with the first magnetic element 32 as the magnetic slide moves. As the first and third magnetic elements begin to move into a magnetically repelling alignment, the magnetic slide 60 reaches the limit of the second guide structure 57. Continued movement of the magnetic slide 60 from this intermediate position via the actuator 70 causes the catch slide 50 to move from the latched position toward the unlatched position. As the catch slide 50 moves, the catch structures 53, 55 and the post fixing flanges 26, 27 move out of engagement thereby allowing disengaging movement of the post 24 along the engagement axis 100. The repelling force between the first and third magnetic elements urges the post, once the catch surfaces and the engaging structures are disengaged, out of the opening in the latch part thereby separating the latch part from the base part and disconnecting the harness buckle.

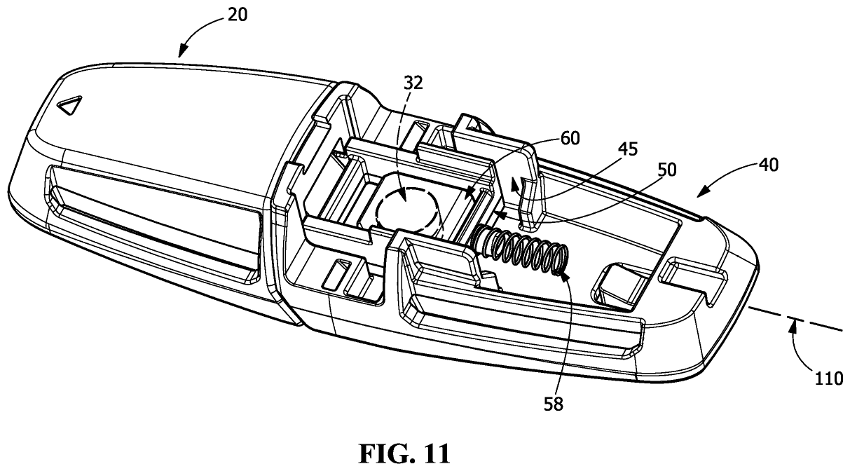

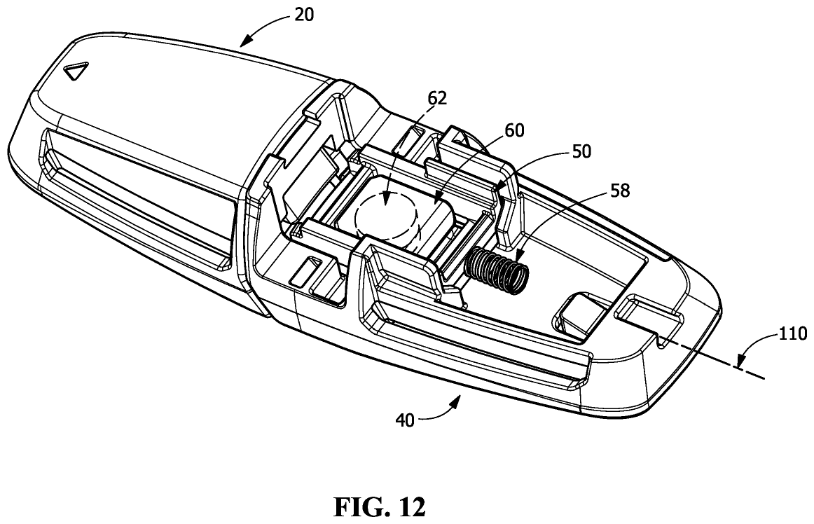

FIGS. 11 and 12 provide a view of the base surface 42 of the latch part 40 showing the relative positioning of the second and third magnetic elements 62, 63 as the magnetic slide 60 is displaced.

One embodiment of the actuator 70 includes a pair of opposing release buttons 72, each moveable along a first actuator axis 120 that is perpendicular to the axis along with the magnetic slide moves. Pressing the release buttons 72 inwardly urges the magnetic slide 60 to displace it from the engaged position. Motion of the release buttons 72 may be transferred to the magnetic slide by a cam arrangement or a linkage. In the illustrated embodiment, inward movement of release buttons 72 acts upon the link elements 69A, 69B which are anchored to magnetic slid 60 at post 64. The free ends engage the respective release buttons while coiled end of the link element encircle post 64. Inward displacement of the free ends of link elements 69A, 69B by release button 72 forces post 64 rearwardly toward the disengaged position, acting against the bias force of second resilient member 68 to release the buckle. In another embodiment, link elements 69A, 69B are joined at the loop encircling post 64 to form a torsion spring configured to bias release buttons 72 outwardly. Inward displacement of the release buttons forces the coiled portion rearwardly to displace the magnetic slide. The arrangement of the torsion spring also provides a biasing force on the magnetic slide similar to that provided by the second resilient member 68, allowing the torsion spring to function as the second resilient member 68.

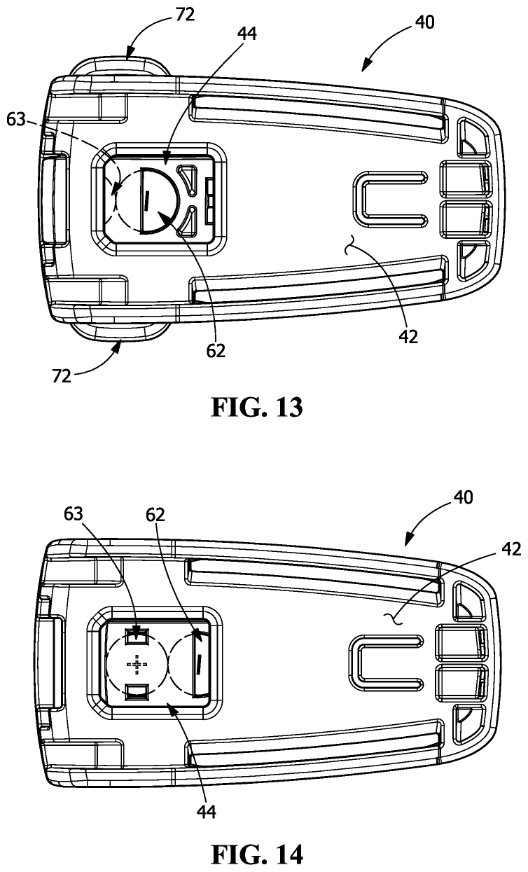

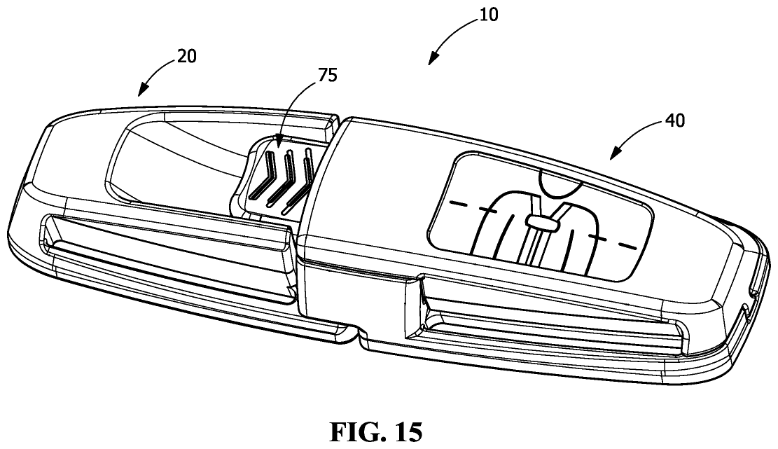

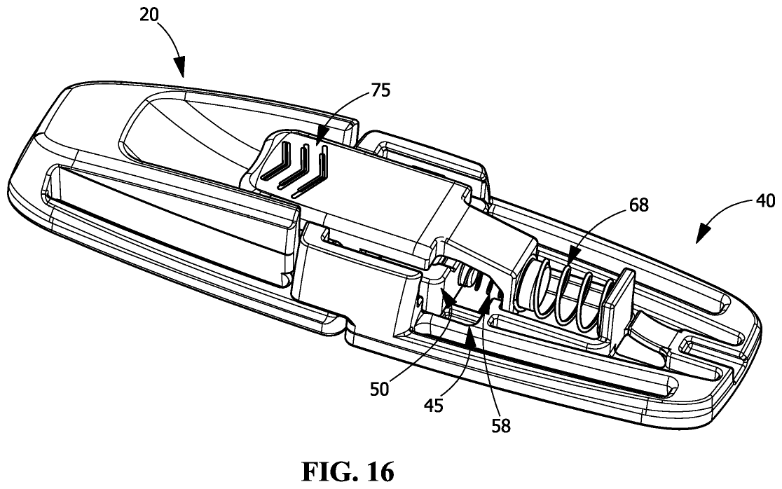

Another embodiment of the actuator shown in FIGS. 13 through 15, an actuator release button 75 may be configured for movement along the same axis as the magnetic slide. The release button may be a separate construct from the magnetic slide, or it may be integral to the magnetic slide structure. Pressing or pushing the release button causes the magnetic slide to move from its engaged position toward the disengaged position and eventually leads to displacement of the catch slide as described above.

Naturally, the invention is not limited to the foregoing embodiments, but it can also be modified in many ways without departing from the basic concepts. Changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Having thus described the invention, what is claimed is:

1. A connector for joining two parts comprising:
a base part having a flange and a first magnetic element; and
a latch part having a receptacle into which a portion of the base part is received, and a first slide and a second slide;
wherein the first slide includes a second magnetic element and a third magnetic element and is moveable between engaging and releasing positions;
wherein movement of the first slide to the engaging position aligns the second magnetic element in a magnetically attractive relation with the first 8 magnetic element and movement to the releasing position aligns the third magnetic element in a magnetically repulsive relation with the first magnetic element;
wherein the second slide is moveable between latched and unlatched positions by movement of the first slide; and
wherein movement of the first slide between engaging and releasing positions is greater than movement of the second slide between latched and unlatched positions.

2. The connector of claim 1, wherein the first and second slides are resiliently biased toward the engaging and latched positions, respectively.

3. The connector of claim 2, further comprising an actuator configured to move the first slide toward the releasing position.

4. The connector of claim 3, wherein the first slide includes a first resilient member and the second slide includes a second resilient member, each resilient member having a respective spring rate, the spring rate of the first resilient member being greater than the spring rate of the second resilient member.

5. A connector for joining two parts comprising:
a base having a flange;
a post extending from the base and having a first magnetic element disposed therein;
a latch part having a receptacle into which a portion of the post may be received;
a first slide having a second magnetic element and a third magnetic element, the second magnetic element being magnetically attracted to the first magnetic element in a closing configuration, the third magnetic element being magnetically repulsive with the first magnetic element in a repelling configuration, the first slide bi-directionally moveable to align the second magnetic element or the third magnetic element with the first magnetic element; and
a second slide bi-directionally moveable to engage or release the flange;
wherein movement of the first slide toward alignment of the third magnetic element with the first magnetic element moves the second slide to release the flange.

6. The connector of claim 5, wherein the post further comprises a second flange and the second slide is bi-directionally moveable to simultaneously engage the flange and the second flange.

7. The connector of claim 6, wherein the first slide is resiliently biased to align the first and second magnetic elements and the second slide is resiliently biased to engage the flanges.

8. The connector of claim 7, further comprising an actuator configured to selectively move the first slide and second slides.

9. The connector of claim 7, wherein the first slide resilient bias is greater than the second slide resilient bias.

10. The connector of claim 5, wherein displacement of the first slide between closing and repelling configurations is greater than displacement of the second slide between the engaging and releasing positions.

11. A connector for joining two parts comprising;
a base having a first flange;
a post extending from the base and having a first magnetic element disposed therein and a second flange;
a latch part having a receptacle into which the post may be received; and
a slide having a second magnetic element and a third magnetic element, the slide being bi-directionally moveable between latched and released positions, movement of the slide to the latch position aligning the second magnetic element in a magnetically attractive relation with the first magnetic element and engaging the first and second flanges, movement of the slide to the released position aligning the third magnetic element in a magnetically repulsive relation with the first magnetic element and disengaging the slide from the flanges thereby allowing the base and latch part to be separated.

12. The connector of claim 11, wherein the slide is resiliently biased toward the latched position.

13. The connector of claim 13, further comprising an actuator configured to move the slide toward the released position.

14. The connector of claim 13, wherein the slide further comprises a catch portion and a magnetic portion, the catch portion being moveable in relation to the magnetic portion and configured to engage the first and second flanges, the second and third magnetic elements being disposed in the magnetic portion.
